(19) United States
(12) Patent Application Publication
(10) Pub. No.: US 2021/0269628 A1
(43) Pub. Date: Sep. 2, 2021

(54) RESIN METAL COMPOSITE BODY AND METHOD FOR PRODUCING SAME

(71) Applicant: IDEMITSU KOSAN CO.,LTD., Tokyo (JP)

(72) Inventors: Naoto OKUBO, Chiba-shi, Chiba (JP); Shinichi MIURA, Ichihara-shi, Chiba (JP); Takaaki UCHIDA, Chiba-shi, Chiba (JP); Hideaki YAMAGUCHI, Chiba-shi, Chiba (JP)

(73) Assignee: IDEMITSU KOSAN CO.,LTD., Tokyo (JP)

(21) Appl. No.: 17/255,950

(22) PCT Filed: Jun. 27, 2019
(86) PCT No.: PCT/JP2019/025738

§ 371 Date: Dec. 23, 2020

(30) Foreign Application Priority Data
Jun. 29, 2018 (JP) 2018-125556

(51) Int. Cl. C08L 25/06; C08K 7/14; C08L 71/12; C08L 21/00; B29C 45/14; B29C 65/00

(52) U.S. Cl. CPC C08L 25/06; C08K 7/14; C08L 71/12; C08L 21/00; C08K 2003/0812; B29C 66/026; B29C 66/72321; B29C 66/032; C08L 2201/10; B29C 45/14

(57) ABSTRACT

A resin metal composite body including a resin member and a metal member, the resin member contains a resin mixture containing a styrene-based resin composition, and a glass filler, the glass filler being 13.0% by mass or more and 37.0% by mass or less based on the resin mixture and the glass filler as 100% by mass, and the styrene-based resin composition contains a styrene-based polymer having a syndiotactic structure, a rubber-like elastomer, and an acid-modified polyphenylene ether, a content of the styrene-based polymer of 62.0% by mass or more and 85.0% by mass or less, a content of the rubber-like elastomer of 12.0% by mass or more and 37.0% by mass or less, and a content of the acid-modified polyphenylene ether of 0.1% by mass or more and 3.9% by mass or less, based on the styrene-based resin composition as 100% by mass.

### TECHNICAL FIELD

The present invention relates to a resin metal composite body and a method for producing the same.

### BACKGROUND ART

A technique for integrating a metal and a resin, which are different materials, is being developed mainly in the fields of electronic and electric machines, automobiles, and electric home appliances. An adhesive is used for bonding a metal and a resin, and various adhesives have been developed. However, the use of an adhesive, particularly in an electronic equipment, requires a process of adhering a molded body of a resin formed through injection molding or the like to a molded body of a metal formed through press molding or die-cast molding with an adhesive, and the molds for injection molding are necessarily produced in a number of the molded bodies of a resin. Furthermore, the positioning in adhering the resin molded body to a metal is necessarily performed strictly.

Moreover, in the fields of electronic equipments, information and communications instruments, such as computers and mobile phones, are strongly demanded to have a reduced size, a reduced weight, and an increased speed, associated with the fast growth of the communication information amount, and a low dielectric constant resin metal composite body capable of addressing the demand is being desired. In the field of information and communication instruments, the use of the high frequency bands, such as the microwave and millimeter wave bands, proceeds due to the decrease of the usable wavelength bands, and the CPU clock frequency is becoming a high frequency reaching the gigahertz band. For the reduction of the size and the weight of the communication instrument capable of being used in the high frequency band, it is necessary to develop a resin metal composite body including a resin member having a low dissipation factor and a low dielectric constant, which does not delay the transmission rate of signals and does not decrease the signal intensity.

A technique for integrating a metal and a resin without the use of an adhesive has been studied. For example, PTLs 1 and 2 describe a composite body of a metal and a resin. PTLs 3 to 5 describe a production method of a metal insert resin composite molded body having an enhanced bonding capability between a metal and a resin composition without the intervention of an adhesive by forming ultrafine pores on the metal surface by a chemical treatment.

### CITATION LIST

### Patent Literatures

PTL 1: JP 2017-39280 A
PTL 2: JP 2014-218076 A
PTL 3: JP 2001-225352 A
PTL 4: JP 2001-225346 A
PTL 5: JP 2001-9862 A

### SUMMARY OF INVENTION

### Technical Problem

PTL 1 describes a polystyrene resin as the resin, but does not specifically describe the resin composition, and the practical bonding strength between the metal and the resin composition is still insufficient. PTL 2 uses a polyphenylene sulfide resin as a major component, and tends to be inferior in electric characteristics. PTLs 3 to 5 target the treatment on a metal surface, and do not refer to the specific resin composition.

### Solution to Problem

The present inventors have investigated to provide a resin metal composite body using a polystyrene-based resin as a major component of the resin molding material, which has a sufficiently high practical bonding strength between a resin member and a metal member and has excellent dielectric characteristics. As a result, it has been found that the problem can be solved by a resin metal composite body including a resin member containing a styrene-based polymer having a syndiotactic structure as a major component and particular components in particular proportions, and a metal member.

The present invention relates to the following items [1] to [16].

[1] A resin metal composite body including a resin member and a metal member,

the resin member containing a resin molding material containing a resin mixture containing a styrene-based resin composition (S), and a glass filler (D), having a content of the glass filler (D) of 13.0% by mass or more and 37.0% by mass or less based on the total of the resin mixture and the glass filler (D) as 100% by mass, with the balance of the resin mixture,

the styrene-based resin composition (S) containing a styrene-based polymer having a syndiotactic structure (A), a rubber-like elastomer (B), and an acid-modified polyphenylene ether (C), having a content of the styrene-based polymer (A) of 62.0% by mass or more and 85.0% by mass or less, a content of the rubber-like elastomer (B) of 12.0% by mass or more and 37.0% by mass or less, and a content of the acid-modified polyphenylene ether (C) of 0.1% by mass or more and 3.9% by mass or less, based on the styrene-based resin composition (S) as 100% by mass.

[2] The resin metal composite body according to the item [1], wherein the rubber-like elastomer (B) is a styrene-based polymer.

[3] The resin metal composite body according to the item [1] or [2], wherein the acid-modified polyphenylene ether (C) is a polyphenylene ether modified with maleic anhydride or modified with fumaric acid.

[4] The resin metal composite body according to any one of the items [1] to [3], wherein the glass filler (D) is a glass filler subjected to a surface treatment.

[5] The resin metal composite body according to the item [4], wherein the glass filler is D glass.

[6] The resin metal composite body according to the item [4] or [5], wherein the glass filler has a fibrous form and has an elliptical fiber cross section.

[7] The resin metal composite body according to any one of the items [1] to [6], wherein the resin metal composite body is an insert molded body.

[8] The resin metal composite body according to any one of the items [1] to [7], wherein the resin mixture substantially does not contain a phosphorus-based antioxidant.

[9] The resin metal composite body according to any one of the items [1] to [8], wherein the metal member is at least one kind selected from the group consisting of aluminum, stainless steel, copper, titanium, and alloys thereof.

[10] The resin metal composite body according to the item [9], wherein the metal member is aluminum or an aluminum alloy.

[11] The resin metal composite body according to any one of the items [1] to [10], wherein the metal member is subjected to at least one selected from a chemical treatment and a physical treatment on at least a surface of the metal member that is in contact with the resin member.

[12] The resin metal composite body according to any one of the items [1] to [11], wherein the metal member has pores formed on at least a surface of the metal member that is in contact with the resin member.

[13] The resin metal composite body according to any one of the items [1] to [12], wherein a test specimen of 1.5 mm×1.5 mm×80 mm of the resin member has a relative dielectric constant (εᵣ) of 2.95 or less measured at a frequency of 10 GHz according to ASTM D2520, and a dissipation factor (tan δ) of 0.0040 or less.

[14] A method for producing the resin metal composite body according to any one of the items [1] to [13], including injection molding the resin molding material on the metal member.

[15] The method for producing the resin metal composite body according to the item [14], wherein the method further includes subjecting the resin metal composite body obtained after injection molding, to cutting work using a working fluid.

[16] A method for producing a resin metal composite body, including subjecting the resin metal composite body according to any one of the items [1] to [13], to an anodization treatment and a pore sealing treatment.

### Advantageous Effects of Invention

According to the present invention, a resin metal composite body that has a bonding portion having a sufficiently high practical bonding strength between a resin member and a metal member and has a low dielectric constant and a low dissipation factor can be provided.

### BRIEF DESCRIPTION OF DRAWINGS

FIG. 1 is an illustration showing the specimen for evaluating the tensile bonding strength used in Examples and Comparative Examples.

FIG. 2 is a perspective view showing the metal resin composite body molded for the drop impact test in Examples and Comparative Examples.

FIG. 3 is a cross sectional view showing the metal resin composite body molded for the drop impact test in Examples and Comparative Examples on the line A-A in FIG. 2.

FIG. 4 is a rear view showing the specimen for the drop impact test used in Examples and Comparative Examples.

FIG. 5 is a front view showing the specimen for the drop impact test used in Examples and Comparative Examples.

FIG. 6 is a schematic illustration showing the structure of the specimen for the drop impact test used in Examples and Comparative Examples.

FIG. 7 is a side view showing the specimen for the drop impact test used in Examples and Comparative Examples.

### DESCRIPTION OF EMBODIMENTS

As a result of the earnest investigations by the present inventors, it has been found that a resin metal composite body that achieves simultaneously the strength of the resin member itself, the high bonding strength at the interface between the metal member and the resin member suppressing exfoliation, and a low dielectric constant and a low dissipation factor can be obtained by specifying the kinds and the amounts of the components constituting the resin member in the case where a polystyrene-based resin having a syndiotactic structure is used as a major component of the resin member. The present invention will be described in detail below.

In the description herein, the expression “XX to YY” means “XX or more and YY or less”. In the description herein, the preferred embodiments may be arbitrarily employed, and a combination of the preferred embodiments may be further preferred.

The resin metal composite body of the present invention includes a resin member and a metal member. The members will be described in detail below.

### 1. Resin Member

In the resin metal composite body of the present invention, it is necessary to use the resin member containing a resin molding material containing a resin mixture containing a styrene-based resin composition (5), and a glass filler (D), having a content of the glass filler (D) of 13.0% by mass or more and 37.0% by mass or less based on the total of the resin mixture and the glass filler (D) as 100% by mass, with the balance of the resin mixture, in which the styrene-based resin composition (5) contains a styrene-based polymer having a syndiotactic structure (A), a rubber-like elastomer (B), and an acid-modified polyphenylene ether (C), and has a content of the styrene-based polymer (A) of 62.0% by mass or more and 85.0% by mass or less, a content of the rubber-like elastomer (B) of 12.0% by mass or more and 37.0% by mass or less, and a content of the acid-modified polyphenylene ether (C) of 0.1% by mass or more and 3.9% by mass or less, based on the styrene-based resin composition (5) as 100% by mass.

### <Styrene-Based Resin Composition (5)>

The styrene-based resin composition (5) contains a styrene-based polymer having a syndiotactic structure (A), a rubber-like elastomer (B), and an acid-modified polyphenylene ether (C), and the total amount of the component (A), the component (B), and the component (C) is 100% by mass.

### <Styrene-Based Polymer Having Syndiotactic Structure (A)>

The styrene-based polymer having a syndiotactic structure (A) means a styrene-based resin having a highly syndiotactic structure (which may be hereinafter referred to as SPS). In the description herein, the term “syndiotactic” means a high proportion of the phenyl rings of the styrene units adjacent to each other that are alternately arranged with respect to the plane constituted by the main chain of the polymer block (which may be hereinafter referred to as syndiotacticity).

The tacticity can be quantitatively identified by the nuclear magnetic resonance method using isotope carbon (i.e., the ¹³C-NMR method). The existing proportions of continuous plural constitutional units, for example, continuous two monomer units as a diad, continuous three monomer units as a triad, and continuous five monomer units as a pentad, can be quantitatively identified by the ¹³C-NMR method.

In the present invention, the “styrene-based resin having a highly syndiotactic structure” means a polystyrene, a poly(hydrocarbon-substituted styrene), a poly(halostyrene), a poly(haloalkylstyrene), a poly(alkoxystyrene), a poly(vinyl benzoate ester), a hydrogenated polymer or a mixture thereof, and a copolymer having these as a major component, each having a racemic diad (r) fraction of generally 75% by mol or more, and preferably 85% by mol or more, or having a racemic pentad (rrrr) fraction of generally 30% by mol or more, and preferably 50% by mol or more.

Examples of the poly(hydrocarbon-substituted styrene) include poly(methylstyrene), poly(ethylstyrene), poly(isopropylstyrene), poly(tert-butylstyrene), poly(phenyl)styrene, poly(vinylnaphthalene), and poly(vinylstyrene). Examples of the poly(halostyrene) include poly(chlorostyrene), poly(bromostyrene), and poly(fluorostyrene), and examples of the poly(haloalkylstyrene) include poly(chloromethylstyrene). Examples of the poly(alkoxystyrene) include poly(methoxystyrene) and poly(ethoxystyrene).

Examples of the comonomer component of the copolymer containing these constitutional units include the monomers of the aforementioned styrene-based polymers, and also include olefin monomers, such as ethylene, propylene, butene, hexene, and octene; diene monomers, such as butadiene and isoprene; cyclic olefin monomers; cyclic diene monomers; and polar vinyl monomers, such as methyl methacrylate, maleic anhydride, and acrylonitrile.

Particularly preferred examples of the aforementioned styrene-based polymer include polystyrene, poly(p-methylstyrene), poly(m-methylstyrene), poly(p-tert-butylstyrene), poly(p-chlorostyrene), poly(m-chlorostyrene), and poly(p-fluorostyrene).

Examples thereof also include a copolymer of styrene and p-methylstyrene, a copolymer of styrene and p-tert-butylstyrene, and a copolymer of styrene and divinylbenzene.

The molecular weight of the SPS (A) is not particularly limited, and the weight average molecular weight thereof is preferably 1×10⁴ or more and 1×10⁶ or less, more preferably 50,000 or more and 500,000 or less, and further preferably 50,000 or more and 300,000 or less, from the standpoint of the flowability of the resin in molding and the mechanical properties of the resulting molded body. In the case where the weight average molecular weight is 1×10⁴ or more, a molded body having sufficient mechanical properties can be obtained. In the case where the weight average molecular weight is 1×10⁶ or less, on the other hand, there may be no problem in the flowability of the resin in molding.

The MFR of the SPS (A) measured under condition of a temperature of 300° C. and a load of 1.2 kgf is preferably 2 g/10 min or more, and more preferably 4 g/10 min or more, and with the MFR in the range, there may be no problem in the flowability of the resin in molding. In the case where the MFR is 50 g/10 min or less, and preferably 30 g/10 min or less, a molded body having sufficient mechanical properties can be obtained.

The SPS (A) of this type can be produced, for example, with reference to the technique described in JP 62-187708 A. Specifically, the SPS can be produced by polymerizing a styrene-based monomer (i.e., a monomer corresponding to the aforementioned styrene-based polymer) with a condensation product of a titanium compound, water, and a trialkyl aluminum as a catalyst in the presence of an inert hydrocarbon solvent or in the absence of a solvent. The poly(haloalkylstyrene) can be produced according to the method described in JP 1-146912 A, and the hydrogenated polymer thereof can be produced according to the method described in JP 1-178505 A.

In the present invention, the styrene-based resin composition (5) contains the SPS (A) in an amount of 62.0% by mass or more and 85.0% by mass or less based on the total of the SPS (A), the rubber-like elastomer (B), and the acid-modified polyphenylene ether (C) as 100% by mass. In the case where the content of the SPS (A) is less than 62.0% by mass, the sufficient tensile bonding strength at the bonding surface between the metal member and the resin member cannot be obtained. In the case where the content of the SPS (A) exceeds 85.0% by mass, it is difficult to provide the sufficient exfoliation bonding strength at the bonding surface between the metal member and the resin member.

The content of the SPS (A) is preferably 65% by mass or more, more preferably 68% by mass or more, and further preferably 70% by mass or more, and is preferably 80% by mass or less, more preferably 78% by mass or less, and further preferably 75% by mass or less, based on the styrene-based resin composition (5) as 100% by mass.

### <Rubber-Like Elastomer (B)>

The resin member constituting the resin metal composite body of the present invention necessarily contains the rubber-like elastomer (B) in the styrene-based resin composition (S). The rubber-like elastomer (B) imparts elasticity and viscosity to the resin member, and thereby can impart significantly high durability to the resin metal composite body. Specifically, the rubber-like elastomer imparts elasticity and viscosity to the resin member, so that the resin metal composite body exhibits high vibration and impact absorbability and simultaneously resolves the strain through dispersion of the internal pressure, and as a result, high bonding strength can be achieved at the bonding interface between the metal member and the resin member.

Examples of the rubber-like elastomer (B) include natural rubber, polybutadiene rubber, polyisoprene rubber, polyisobutylene rubber, neoprene rubber, polysulfide rubber, thiol rubber, acrylic rubber, urethane rubber, silicone rubber, epichlorohydrin rubber, ethylene-propylene rubber, ethylene-propylene-diene rubber, rubber obtained modifying these kinds of rubber, and also include at least one kind of a styrene-based polymer selected from the group consisting of a styrene-butadiene block copolymer, a styrene-isoprene block copolymer, a styrene-butadiene-styrene block copolymer, a styrene-isoprene-styrene block copolymer, a styrene-ethylene-propylene-styrene block copolymer, a styrene-ethylene-ethylene-propylene-styrene block copolymer, a styrene-ethylene-butylene-styrene block copolymer, a styrene-isoprene-butadiene-styrene block copolymer, and hydrogenated products of these materials. Among these, at least one kind of a styrene-based polymer selected from a styrene-ethylene-butylene-styrene block copolymer, a styrene-butadiene block copolymer, and a styrene-butadiene-styrene block copolymer is preferred, and a styrene-ethylene-butylene-styrene block copolymer is more preferred. Two or more kinds of styrene-ethylene-butylene-styrene block copolymers are further preferably used. The use of two or more kinds of styrene-ethylene-butylene-styrene block copolymers can enhance the controllable ranges of the molecular weight and the styrene content, resulting in the resin member that is excellent in toughness and strength within the balance of the other resin molding materials.

The molecular weight of the rubber-like elastomer correlates to the MFR thereof, and therefore can be evaluated indirectly by the MFR measured according to ISO 1133-1:2011. In the present invention, the MFR of the rubber-like elastomer under measurement condition of a temperature of 230° C. and a load of 2.16 kgf is preferably 0.0 (no flow) to 10.0 g/10 min. With the MFR of 10.0 g/10 min or less, sufficient strength can be obtained. With the MFR of 0.0 g/10 min or more, the dispersibility of the rubber-like elastomer in the resin mixture can be favorably retained.

In the case where the rubber-like elastomer (B) contains a styrene-based polymer, the styrene content thereof is preferably 25% by mass or more and 35% by mass or less. With the styrene content of 35% by mass or less, sufficient toughness can be imparted. With the styrene content of 25% by mass or more, excellent compatibility with the styrene-based resin having a syndiotactic structure can be obtained.

In the present invention, the styrene-based resin composition (S) contains the rubber-like elastomer (B) in an amount of 12.0% by mass or more and 37.0% by mass or less based on the total of the SPS (A), the rubber-like elastomer (B), and the acid-modified polyphenylene ether (C) as 100% by mass. In the case where the content of the rubber-like elastomer (B) is less than 12.0% by mass, the sufficient exfoliation bonding strength at the bonding surface between the metal member and the resin member cannot be obtained in the resulting resin metal composite body. In the case where the content of the rubber-like elastomer (B) exceeds 37.0% by mass, it is difficult to provide the sufficient tensile bonding strength at the bonding surface between the metal member and the resin member in the resulting resin metal composite body.

The content of the rubber-like elastomer (B) is preferably 15% by mass or more, more preferably 18% by mass or more, and further preferably 20% by mass or more, and is preferably 35% by mass or less, more preferably 33% by mass or less, and further preferably 30% by mass or less, based on the styrene-based resin composition (S) as 100% by mass.

### <Acid-Modified Polyphenylene Ether (C)>

The styrene-based resin composition (S) contained in the resin member of the resin metal composite body of the present invention contains an acid-modified polyphenylene ether (C). The acid-modified polyphenylene ether (C) contained in the styrene-based resin composition (S) can enhance the interface strength between the resin mixture and the glass filler (D) described later, and thereby can enhance the strength of the resin member.

The acid-modified polyphenylene ether (C) is a compound obtained through acid modification of a polyphenylene ether. The polyphenylene ether used may be a known compound, and preferred examples thereof include poly(2,3-dimethyl-6-ethyl-1,4-phenylene ether), poly(2-methyl-6-chloromethyl-1,4-phenylene ether), poly(2-methyl-6-hydroxyethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly(2-(4′-methylphenyl)-1,4-phenylene ether), poly(2-bromo-6-phenyl-1,4-phenylene ether), poly(2-methyl-6-phenyl-1,4-phenylene ether), poly(2-phenyl-1,4-phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), poly(2,6-diethyl-1,4-phenylene ether), and poly(2,6-dimethyl-1,4-phenylene ether). In addition, the compounds described in U.S. Pat. Nos. 3,306,874, 3,306,875, 3,257,357, and 3,257,358 may also be used.

The polyphenylene ether is generally prepared through oxidation coupling reaction forming a homopolymer or a copolymer in the presence of a copper-amine complex and a substituted phenol having one or more substituent. The copper-amine complex may be a copper-amine complex derived from a primary, secondary, or tertiary amine.

The acid-modified polyphenylene ether (C) used is preferably a maleic anhydride-modified or fumaric acid-modified polyphenylene ether.

Examples of the acid used for the acid modification include maleic anhydride and a derivative thereof, and fumaric acid and a derivative thereof. The derivative of maleic anhydride is a compound that has an ethylenic double bond and a polar group, such as a carboxy group or an acid anhydride group, in one molecule. Specific examples thereof include maleic acid, a maleate monoester, a maleate diester, a maleimide and an N-substituted compound thereof (such as an N-substituted maleimide, a maleic acid monoamide, and a maleic acid diamide), an ammonium salt of maleic acid, a metal salt of maleic acid, acrylic acid, methacrylic acid, a methacrylate ester, and glycidyl methacrylate. Specific examples of the derivative of the fumaric acid include a fumarate diester, a metal salt of fumaric acid, an ammonium salt of fumaric acid, and a halide of fumaric acid. Among these, fumaric acid and maleic anhydride are particularly preferred.

In the present invention, the styrene-based resin composition (5) contains the acid-modified polyphenylene ether (C) in an amount of 0.1% by mass or more and 3.9% by mass or less based on the total of the SPS (A), the rubber-like elastomer (B), and the acid-modified polyphenylene ether (C) as 100% by mass. In the case where the content of the acid-modified polyphenylene ether (C) is less than 0.1% by mass, the interface strength between the SPS (A) and the glass fibers becomes insufficient, and the strength of the resin member becomes insufficient. In the case where the content of the acid-modified polyphenylene ether (C) exceeds 3.9% by mass, the color tone is deteriorated, and the degree of freedom in coloring is decreased.

The content of the acid-modified polyphenylene ether (C) is preferably 1.0% by mass or more, and more preferably 1.5% by mass or more, and is preferably 3.0% by mass or less, and more preferably 2.5% by mass or less, based on the styrene-based resin composition (S) as 100% by mass. The acid-modified polyphenylene ether may be used alone or as a combination of two or more kinds thereof.

### <Additional Components>

The resin mixture containing the styrene-based resin composition (S) may contain additional additives depending on desire. Examples thereof include an antioxidant, a light stabilizer, a nucleating agent, and an antistatic agent.

### <Antioxidant>

A known antioxidant may be used, but in the present invention, a phosphorus-based antioxidant is preferably substantially not contained. A phosphorus-based antioxidant is preferably not contained as far as possible since the use thereof may generate phosphoric acid gas in molding, which tends to accelerate metal corrosion. The expression that “a phosphorus-based antioxidant is substantially not contained” specifically means that the amount of a phosphorus-based antioxidant is 5,000 ppm by mass or less, more preferably 1,000 ppm by mass or less, further preferably 500 ppm by mass or less, and still further preferably 50 ppm by mass or less, in the styrene-based resin composition (S).

The antioxidant used is preferably a phenol-based antioxidant. Examples of the phenol-based antioxidant include triethylene glycol bis(3-(3-tert-butyl-5-methyl-4-hydroxyphenyl)propionate), 1,6-hexanediol bis(3-(3,5-di-tert-butyl-4-hydroxyphenyl)propionate), pentaerythryl tetrakis(3-(3,5-di-tert-butyl-4-hydroxyphenyl)propionate), octadecyl 3-(3,5-di-tert-butyl-4-hydroxyphenyl)propionate, 3,5-di-tert-butyl-4-hydroxybenzyl phosphonate diethyl ester, N,N′-hexamethylenebis(3, 5-di-tert-butyl-4-hydroxyhydrocinnamamide, 1,3,5-trimethyl-2,4,6-tris(3,5-di-tert-butyl-4-hydroxybenzyl)benzene, and 3,9-bis(2-(3-(3-tert-butyl-4-hydroxy-5-methylphenyl)propynyloxy)-1,1-dimethylethyl)-2,4,8,10-tetraoxaspiro[5,5]undecane.

The antioxidant mixed can decrease the thermal decomposition in kneading and molding. The content of the antioxidant in the resin mixture is preferably 0.05 part by mass or more, and more preferably 0.10 part by mass or more, and is preferably 0.50 part by mass or less, and more preferably 0.30 part by mass or less, per 100 parts by mass of the styrene-based resin composition (S). The antioxidant may be used alone or as a combination of two or more kinds thereof. In the case where plural kinds of the antioxidants are contained, the total amount thereof is applied to the aforementioned range.

### <Nucleating Agent>

A nucleating agent (crystallization nucleating agent) contained in the resin mixture can retain the appropriate crystallization rate in molding resin pellets, and the mass productivity of the pellets can be secured.

A known nucleating agent may be used, and examples thereof include a metal salt of a carboxylic acid, such as aluminum di(p-tert-butylbenzoate), a metal salt of phosphoric acid, such as sodium 2,2′-methylenebis(4,6-di-tert-butylphenyl)phosphate and sodium methylenebis(2, 4-di-tert-butylphenol) acid phosphate, a phthalocyanine derivative, and a phosphate ester-based compound.

In the case where the resin mixture contains the nucleating agent, the content of the nucleating agent is preferably 0.2 part by mass or more, and more preferably 0.5 part by mass or more, and is preferably 2.0 parts by mass or less, and more preferably 1.5 parts by mass or more, per 100 parts by mass of the styrene-based resin composition (S). With the content thereof of 0.2 part by mass or more, excellent mass productivity of the pellets of the resin molding material constituting the resin member can be obtained, and with the content thereof of 2.0 parts by mass or less, the resin metal composite body can be excellent in relative dielectric constant and dissipation factor. The nucleating agent may be used alone or as a combination of two or more kinds thereof.

### <Glass Filler (D)>

The resin molding material constituting the resin member of the metal composite body of the present invention contains the resin mixture containing the styrene-based resin composition (5), and the glass filler (D).

The glass filler (D) can impart strength to the resin member and can decrease the molding shrinkage ratio of the resin in molding. In the resin metal composite body, the capability of decreasing the molding shrinkage ratio can decrease the residual stress at the interface between the resin and the metal, and the excellent resin metal composite body can be obtained since the problems including exfoliation and deformation thereof can be suppressed. Furthermore, the glass filler (D) contained can enhance the elastic modulus of the resin member. In the resin metal composite body, the stress concentration to the interface between the resin member and the metal member can be reduced with the elastic moduli of the members that are closer to each other, and therefore the increase of the elastic modulus of the resin member can enhance the drop impact characteristics of the resin metal composite body.

The form of the glass filler (D) is not particularly limited, and various forms, such as a fibrous form, a particulate form, a plate form, and a powder form, may be used. The fibrous glass filler used may be a glass filler having a cross section that is an approximate true circler shape or an elliptical shape. Among these, a glass filer that is in a fibrous form having an elliptical (flat) fiber cross sectional shape (i.e., flat glass fibers) is more preferably used since the resin member can be excellent in molding shrinkage ratio and bending elastic modulus in TD (transverse direction, which is the direction perpendicular to the flowing direction of the resin).

Specific examples of the glass filler preferably used include glass powder, glass flakes, glass beads, glass filaments, glass fibers, glass roving, and glass mat. For enhancing the affinity to the resin, it is effective to subject the glass filler to a surface treatment. The surface treatment of the glass filler may be performed, for example, with a coupling agent, which may be arbitrarily selected from known materials, such as a silane coupling agent, e.g., an aminosilane series, an epoxysilane series, a vinylsilane series, and a methacrylsilane series, and a titanium coupling agent.

Among these, an aminosilane and an epoxysilane, such as γ-aminopropyltrimethoxysilane, N-ß-(aminoethyl)-γ-aminopropyltrimethoxysilane, γ-glycidoxypropyltrimethoxysilane, and ß-(3,4-epoxycyclohexyl)ethyltrimethoxysilane, and isopropyl tri(N-amidoethyl aminoethyl) titanate are preferably used as the surface treatment agent. The surface treatment method for the glass filler may be a known method and is not particularly limited.

Examples of the kind of glass include E glass, C glass, S glass, D glass, ECR glass, A glass, and AR glass. E glass or D glass is preferably used particularly for providing a low dielectric constant for the resin metal composite body. Examples of E glass include glass having a composition containing 52% by mass or more and 56% by mass or less of SiO₂, 12% by mass or more and 16% by mass or less of Al₂O₃, 15% by mass or more and 25% by mass or less of CaO, 0% by mass or more and 6% by mass or less of MgO, 5% by mass or more and 13% by mass or less of B₂O₃, and 0% by mass or more and 2% by mass or less in total of Na₂O and K₂O. Examples of D glass include glass having a composition containing 72% by mass or more and 76% by mass or less of SiO₂, 0% by mass or more and 5% by mass or less of Al₂O₃, 20% by mass or more and 25% by mass or less of B₂O₃, and 3% by mass or more and 5% by mass or less in total of Na₂O and K₂O.

The content of the glass filler (D) in the resin molding material constituting the resin member of the present invention is preferably 13.0% by mass or more and 37.0% by mass or less based on the total of the resin mixture and the glass filler (D) as 100% by mass. The content of the glass filler (D) that is less than 13.0% by mass is not preferred since the resin member may be inferior in internal strength and may have an increased molding shrinkage ratio of the resin in molding, which makes the bonding to the metal insufficient. The content of the glass filler (D) that exceeds 37.0% by mass is not preferred since the dielectric constant of the resulting resin metal composite body may be increased.

The content of the glass filler (D) in the resin molding material is preferably 15.0% by mass or more, and more preferably 18.0% by mass or more, and is preferably 35.0% by mass or less, and more preferably 33.0% by mass or less.

In molding the resin metal composite body of the present invention, the metal member is placed in a mold for injection molding, and then injection molding is performed. Therefore, a release agent may not be necessarily used since the release resistance applied to between the mold and the resin in releasing the resin from the mold becomes smaller than the case where injection molding is performed only with a resin (composition). A release agent is preferably not contained since the release agent tends to decrease the viscosity of the resin molding material, and brings about the possibility of generating gas in molding. Examples of the release agent include polyethylene wax, a silicone oil, a long-chain carboxylic acid, and a metal salt of a long-chain carboxylic acid. Examples of the commercially available trade name thereof include SH-200-13000CS and SH-550 (produced by Dow Corning Toray Co., Ltd.), KF-53 (produced by Shin-Etsu Silicone Co., Ltd.), and Lico Wax OP (produced by Clariant Japan Co., Ltd. In the case where the resin member contains a release agent, the release agent exists in the vicinity of the interface between the resin member and the metal member to influence the bonding strength. Accordingly, the expression that “a release agent is not contained” specifically means that the amount of the release agent is 0.6% by mass or less based on the resin member (i.e., the total of the resin mixture and the glass filler (D)) as 100% by mass.

A neutralizing agent is also preferably not contained in the resin molding material constituting the resin member of the resin metal composite body of the present invention. In the present invention, a phosphorus-based antioxidant, which forms an acid component, is preferably not contained as described above, and therefore there is only less necessity of a neutralizing agent in the case where a phosphorus-based antioxidant is not contained. In addition, a neutralizing agent is not preferred since it also has a tendency of increasing the relative dielectric constant and the dissipation factor of the resin metal composite body. Specific examples of the neutralizing agent include at least one kind of a neutralizing agent selected from basic metal salts, particularly a compound containing calcium element, a compound containing aluminum element, and a compound containing magnesium element. The expression that “a neutralizing agent is not contained” specifically means that the amount of the neutralizing agent is 0.30% by mass or less based on the resin molding material (i.e., the total of the resin mixture and the glass filler (D)) as 100% by mass.

The resin molding material constituting the resin member of the resin metal composite body of the present invention may be prepared in such a manner that the aforementioned essential components and the arbitrary components used depending on demand are mixed at the prescribed ratios and sufficiently kneaded with a Banbury mixer, a single screw extruder, a twin screw extruder, or the like, at an appropriate temperature, for example, a temperature in a range of 270 to 320° C. The resin molding material may be molded into a desired form, for example, a pellet form, by various molding methods.

As described above, the resin member constituting the resin metal composite body of the present invention has a low dielectric constant and a low dissipation factor as one of the features thereof. Specifically, a test specimen of 1.5 mm×1.5 mm×80 mm of the resin member preferably has a relative dielectric constant (εᵣ) of 2.95 or less measured at a frequency of 10 GHz according to ASTM D2520, and a dissipation factor (tan δ) of 0.0040 or less, thereby providing an advantage that the transmission rate of signals in a high frequency band is not delayed, and the intensity of the signals is not lowered.

The relative dielectric constant (εᵣ) of the resin member is more preferably 2.85 or less, and the dissipation factor (tan δ) thereof is more preferably 0.0030 or less.

### 2. Metal Member

The metal member constituting the resin metal composite body of the present invention is preferably at least one kind selected from the group consisting of aluminum, stainless steel, copper, titanium, and alloys thereof. These metals may be selected depending on the target application and properties, and aluminum and an aluminum alloy are more preferably used. Examples of the aluminum and the aluminum alloy containing aluminum include A1050, A1100, and A1200 as an industrial pure aluminum series, A2017 and A2024 as an Al—Cu series, A3003 and A3004 as an Al—Mn series, A4032 as an Al—Si series, A5005, A5052, and A5083 as an Al—Mg series, A6061 and A6063 as an Al—Mg—Si series, and A7075 as an Al—Zn series. In the case where the resin metal composite body is used as a chassis of an information and communications instrument, such as a mobile phone, an aluminum alloy and stainless steel are preferred from the standpoint of weight, strength, and working.

The shape of the metal member is not particularly limited, as far as the shape enables bonding to the resin member, and examples thereof include a flat plate shape, a curved plate shape, a bar shape, a cylindrical shape, and a bulk shape. A structure including a combination of these shapes may also be used. The form of the surface of the bonding portion, through which the resin member is bonded, is not particularly limited, and examples thereof include a flat surface and a curved surface. A form that can suppress the stress concentration is more preferred for retaining the bonding strength.

The metal member may be provided through die-cast molding, extrusion molding, or the like of a metal material. It is preferred that the metal material obtained through the molding and the like is worked into a prescribed shape by subjecting to plastic working by cutting, pressing, or the like, punching work, and cutout work, such as cutting, grinding, electrospark machining, and the like, and then subjected to a surface treatment described later.

The metal member may be subjected to a surface treatment, such as physical, chemical, or electric surface roughening, and is preferably subjected to at least one selected from a physical treatment and a chemical treatment. In the case where at least a part of, preferably the whole of, the surface of the metal member that is in contact with the resin member is subjected to the surface treatment, the resin metal composite body having particularly excellent bonding capability between the metal member and the resin member can be obtained.

The physical treatment and the chemical treatment are not particularly limited, and the known physical treatments and chemical treatments may be used. The physical treatment roughens the surface of the metal member, and the resin mixture constituting the resin member enters the pores formed in the roughened area to generate the anchoring effect, which facilitates the enhancement of the adhesiveness at the interface between the metal member and the resin member. The chemical treatment imparts a chemical adhesion effect, such as covalent bond, hydrogen bond, and intermolecular force, to between the metal member and the resin member integrally molded therewith, which thus facilitates the enhancement of the adhesiveness at the interface between the metal member and the resin member. The chemical treatment may also perform roughening of the surface of the metal member, and in this case, the anchoring effect is generated as similar to the physical treatment, which further facilitates the enhancement of the adhesiveness at the interface between the metal member and the resin member.

Various methods may be used as the method of the surface treatment. Examples of the physical treatment include a laser treatment and sand blasting (see JP 2001-225346 A). Plural physical treatments may be used in combination. Examples of the chemical treatment include a dry treatment, such as corona discharge, a triazine treatment (see JP 2000-218935 A), chemical etching (see JP 2001-225352 A), an anodization treatment (see JP 2010-64496 A), and a hydrazine treatment. In the case where the metal material constituting the insert metal member is aluminum, examples of the treatment also include a hot water treatment (see JP 1108-142110 A). Examples of the hot water treatment include immersion in water at 100° C. for 3 to 5 minutes. Plural chemical treatments may be used in combination. The methods of the surface treatment may be used alone or as a combination of two or more kinds thereof.

For enhancing the anchoring effect of the metal member, it is preferred that pores are formed on at least a part of the surface of the metal member that is in contact with the resin member. Specifically, it is preferred that large pores are formed on the surface of the metal member, and fine pores are further formed in the pores.

The case where the metal member is aluminum or an aluminum alloy (which may be hereinafter referred to as an aluminum (alloy)) will be specifically described below.

In bonding the metal member and the resin member through injection molding or the like, an aluminum (alloy) can be worked from a metal material to a desired shape through machining, such as sawing, milling, discharging, drilling, forging, pressing, cutting, and grinding, and thus can be finished to a shape that is required for an insert member to an injection molding die. The metal member having been finished to the necessary shape generally has attached thereto an oil material used in working in many cases. Therefore, a degreasing treatment is preferably performed before the formation of fine pores on the surface thereof. The degreasing treatment is preferably a process of removing the working fluid by using a solvent degreasing equipment with a solvent, such as trichlene, methylene chloride, kerosene, and a paraffin-based oil agent.

Subsequently, a degreasing and cleaning treatment in a liquid is preferably performed. This is performed for removing the working fluid for the machining, such as cutting and grinding, dirt, such as sebum of fingers, and the like attached to the surface of the aluminum (alloy). In the case where a large amount of the working fluid is attached, it is preferred that the aluminum (alloy) is firstly subjected to the aforementioned solvent degreasing equipment, and then subjected to this treatment. The degreasing agent used herein may be a commercially available degreasing agent for an aluminum alloy. In the use of a commercially available degreasing agent for an aluminum alloy, it is preferred that the degreasing agent is dissolved in water to prepare a degreasing agent aqueous solution, in which the aluminum (alloy) member is immersed at the specified temperature for the specified time, for example, at 50 to 80° C. for approximately 5 minutes. After immersing, the aluminum (alloy) member is cleaned with water.

A pretreatment process is preferably performed in such a manner that the aluminum (alloy) member is roughly etched by immersing in an acidic or basic solution for several minutes for chemically removing the surface film, and then an anodization treatment or the like is performed for forming fine pores. In the pretreatment process, an acidic aqueous solution is preferably used, and an aqueous solution containing hydrofluoric acid or a derivative of hydrofluoric acid may be used as the acidic liquid. It is preferred that the aluminum (alloy) member is roughly etched by immersing in an acidic or basic solution for several minutes for chemically removing the surface film, so as to make suitable for the subsequent process. After cleaning with water, the aluminum (alloy) member is subjected to a treatment for forming fine pores.

Examples of the method of forming fine pores on the metal surface include a method using laser, as described in Japanese Patent No. 4,020,957; a method of treating the metal member by an anodization method, as described in Japanese Patent No. 4,541,153; a substitution crystallization method of etching with an aqueous solution containing an inorganic acid, ferric ion, cupric ion, and manganese ion, as described in JP 2001-348684 A; and a method of immersing the metal member in an aqueous solution of one or more selected from hydrated hydrazine, ammonia, and a water soluble amine compound (which may be hereinafter referred to as an NMT method), as described in WO 2009/31632. Among these, a method of treating the metal member by an anodization method, as described in Japanese Patent No. 4,541,153, is preferred.

The metal member preferably has plural pores having a diameter of 0.01 μm or more and 1,000 μm or less formed on the surface that is in contact with the resin member. With plural pores having a diameter of 0.01 μm or more and 1,000 μm or less formed thereon, the resin metal composite body that is further excellent in bonding capability between the metal member and the resin member can be obtained. The pores are more preferably 0.01 μm or more and 100 μm or less.

### 3. Method for Producing Resin Metal Composite Body

The resin metal composite body can be obtained by integrally molding the metal member and the resin member. Examples of the integral molding method include insert molding, fusion method, outsert molding, and overlay molding.

The “insert molding” is a method for providing a molded body having the metal member and the resin member integrated with each other by inserting the metal member into a mold having a prescribed shape, and then filling the mold with the resin member, and a known method may be employed therefor. The method is not particularly limited, as far as the method can provide the resin metal composite body by charging the resin into the pores formed on the metal member, for example, by applying pressure to the molten resin, followed by cooling and solidifying the resin. Examples of the filling method of the resin include injection molding and compression molding, and also include injection compression molding, and an injection molding method is more preferred.

The method for retaining the metal member in the mold is not particularly limited, and a known method may be used, examples of which include a method of fixing with a pin or the like, and a method of fixing with a vacuum line. The insert molded body obtained through insert molding has the bonding portion between the resin member and the metal member, and the shape thereof is not limited. Examples thereof include a shape having the resin and the metal overlaid each other, and a shape having the metal member enclosed with the resin member.

The temperature of the metal member in the insert molding is preferably 150° C. or more and 180° C. or less. In the case where the temperature of the metal member is 150° C. or more, the pores formed on the metal member can be sufficiently filled with the resin member, and an excellent bonding strength can be obtained. In the case where the temperature of the metal member exceeds 180° C., the shrinkage and deformation of the resin member in the cooling process may be increased to prevent the target shape from being obtained, and simultaneously, the energy necessary for heating and cooling may be increased, and the molding cycle time may be increased.

The method for making the temperature of the metal member within the aforementioned range is not particularly limited, and examples thereof include a controlling method through a temperature controlling mechanism of the mold.

In the method of performing integral molding by the fusion method, the resin member is fused on the metal member through vibration fusion, ultrasonic fusion, hot plate fusion, or spin fusion. The fusion condition for performing the fusion is not particularly limited, and may be appropriately set depending on the shape of the molded body and the like.

The fusion method is preferably a method which includes bringing the metal member and the resin member into contact with each other, and generating frictional heat at the contact surface thereof to perform the fusion. Examples of the fusion method which includes generating frictional heat at the contact surface include a vibration fusion method, an ultrasonic fusion method, and a spin fusion method.

The size, the shape, the thickness, and the like of the resulting resin metal composite body are not particularly limited, and may be any of a plate shape (such as a circular shape and a polygonal shape), a column shape, a box shape, a bowl shape, a tray shape, and the like. In the large-size composite body and the composite body having a complicated shape, the thickness of the composite body may not be necessarily uniform over the entire portion of the composite body, and a reinforcing rib may be provided in the composite body.

The resulting resin metal composite body may be further worked by cutting work, grinding work, and the like. Examples of the cutting work include turning, milling, boring, drilling (such as perforating, tapping, and reaming), gear cutting, plaining, shaping, slotting, broaching, and gear shaping. A known working fluid is preferably used in the cutting work.

The working fluid may also be preferably used in both wet working and near dry working. The method of feeding the working fluid may be circulation feeding of feeding a large amount of the working fluid to the working point, or may be a so-called MQL (minimum quantity lubrication) of feeding a carrier gas and a metal working fluid composition in the form of mist to the working point.

The surface of the resin metal composite body before working and the resin metal composite body after the aforementioned working is preferably subjected to a physical treatment and/or a chemical treatment. These treatments performed can impart design, such as coloration, to the resin metal composite body and can protect and strengthen the surface of the resin metal composite body.

The treatment of the surface of the resin metal composite body may be the same method as described above. For example, in the case where a chemical treatment is performed, as described above, such a method may be used that the working fluid used for working the resin metal composite body is removed by degreasing, the surface is roughly etched with an acidic or basic solution, and then fine pores are formed on the surface. The method of forming fine pores on the surface herein is also preferably an anodization treatment. The condition therefor may be as described above.

The resin metal composite body after the anodization treatment may be applied to various purposes without any further treatment, but the anodized film formed after the anodization treatment is relatively inferior in electric insulation property and corrosion resistance. Therefore, the portion of the resin metal composite body that is exposed to outside air is preferably subjected to a pore sealing treatment. Examples of the pore sealing treatment include a pore sealing treatment with a hydrate. More specifically, examples thereof include a steam treatment and a hot water treatment applied to an anodized film having fine pores formed by an anodization treatment. In the case where the resin metal composite body is colored, the pore sealing treatment may be performed while coloring to a desired color through a known desired coloration measure, such as various dyes, e.g., the use of an acidic dye, a mordant dye, and a basic dye, for example, by using a dye bath at a bath temperature of 50 to 70° C. The SPS resin used in the resin member of the resin metal composite body of the present invention is preferred from the standpoint of the treatment of this type, since it is excellent in chemical resistance and hot water resistance, and thus can withstand the treatment.

As the surface layer of the resin metal composite body of the present invention, a hardcoat layer may be provided for the purpose of scratch prevention, fingerprint prevention, static charge prevention, and the like. The hardcoat layer used may be an arbitrary one, and for example, a film formed of a photocurable composition containing a photocurable polyfunctional compound and a urethane (meth)acrylate may be formed on the metal resin composite body.

### EXAMPLES

The present invention will be described more specifically with reference to examples, but the present invention is not limited thereto.

The materials used in Examples and Comparative Examples are shown below.

### <Styrene-Based Resin Composition (S)>

Polystyrene polymer having syndiotactic structure (A-1): Syndiotactic polystyrene homopolymer, produced by Idemitsu Kosan Co., Ltd., trade name: 90ZC, melting point: 270° C., racemic pentad tacticity: 98%, MFR: 9.0 g/10 min (temperature: 300° C., load: 1.2 kgf)

Polystyrene polymer having syndiotactic structure (A-2): Syndiotactic polystyrene homopolymer, produced by Idemitsu Kosan Co., Ltd., trade name: 60ZC, melting point: 270° C., racemic pentad tacticity: 98%, MFR: 6.0 g/10 min (temperature: 300° C., load: 1.2 kgf)

Polystyrene polymer having syndiotactic structure (A-3): Syndiotactic polystyrene homopolymer, produced by Idemitsu Kosan Co., Ltd., trade name: 30ZC, melting point: 270° C., racemic pentad tacticity: 98%, MFR: 3.0 g/10 min (temperature: 300° C., load: 1.2 kgf)

Rubber-like elastomer (B-1): Styrene-ethylene-butylene-styrene block copolymer, styrene content: 33% by mass, produced by Kuraray Co., Ltd., trade name: Septon 8006, MFR: 0.0 g/10 min (no flow) (230° C., 2.16 kgf)

Rubber-like elastomer (B-2): Styrene-ethylene-butylene-styrene block copolymer, styrene content: 30% by mass, produced by Asahi Kasei Corporation, trade name: Tuftec H1041, MFR: 5.0 g/10 min (230° C., 2.16 kgf)

### Acid-Modified Polyphenylene Ether (C)

1 kg of a polyphenylene ether (intrinsic viscosity: 0.45 dL/g, in chloroform at 25° C.), 40 g of fumaric acid, and 20 g of 2,3-dimethyl-2,3-diphenylbutane (produced by NOF Corporation, trade name: Nofmer BC) as a radical generator were dry-blended and melt-kneaded with a twin screw extruder, TEX44αII (produced by The Japan Steel Works, Ltd.) at a barrel temperature of 300 to 330° C., a screw rotation number: 360 rpm, and a discharge rate of 110 kg/hr, so as to provide pellets of a fumaric acid-modified polyphenylene ether. For measuring the modification rate, 1 g of the fumaric acid-modified polyphenylene ether pellets were dissolved in ethylbenzene and the reprecipitated from methanol, and the recovered polymer was subjected to Soxhlet extraction with methanol, and after drying, measured for the modification rate by the carbonyl absorption intensity in the IR spectrum and the titration. The modification rate at this time was 1.25% by mass.

Nucleating agent: sodium 2,2′-methylenebis(4,6-di-tert-butylphenyl)phosphate, produced by ADEKA Corporation, trade name: Adeka Stab NA-11

Phenol-based antioxidant: trade name: Irganox 1010, produced by BASF Japan Ltd.

Glass filler (D-1): ECS03T-249H (produced by Nippon Electric Glass Co., Ltd., E glass, fibrous (chopped strand length: 3 mm), fiber cross section: approximate true circler shape (diameter: 10.5 μm))

Glass filler (D-2): CS(HL)301HP-3 (produced by CPIC, D glass, fibrous (chopped strand length: 3 mm), fiber cross section: approximate true circler shape (diameter: 13 μm))

Glass filler (D-3): CSG3PA-820 (produced by Nitto Boseki Co., Ltd., E glass, fibrous (chopped strand length: 3 mm), fiber cross section: ellipsoidal shape (short diameter: 7 μm, long diameter: 28 μm))

In Comparative Examples, the following materials were used as the inorganic filler.

Wollastonite: NYGLOS 12 (produced by Tomoe Engineering Co., Ltd.)

Talc: TP-A25 (produced by Fuji Talc Industrial Co., Ltd.)

Calcium carbonate: Whiton P30 (produced by Toyo Fine Chemical Co., Ltd.)

### Examples 1 to 17 and Comparative Examples 1 to 21

### I. Production of Resin Molding Material

The components constituting the resin member except for the glass filler and the other organic fillers described in Tables 1-1 to 2-3 were mixed and dry-blended with a Henschel mixer to provide a resin mixture. Subsequently, the resulting resin mixture was melt-kneaded with a twin screw kneader-extruder, TEM-35B (produced by Toshiba Machine Co., Ltd.) at a barrel temperature of 270 to 290° C., a screw rotation number of 220 rpm, and a discharge rate of 25 kg/hr, while feeding the glass filler or the other inorganic fillers thereto, so as to provide pellets (resin molding material). The pellets obtained through the melt kneading were dried at 120° C. for 5 hours with a hot air dryer.

In the tables, the contents of (% by mass) of the SPS (A), the rubber-like elastomer (B), and the acid-modified polyphenylene ether (C) are shown in terms of proportion in the styrene-based resin composition (5) as 100% by mass. The contents (part by mass) of the nucleating agent and the antioxidant are shown in terms of content per 100 parts by mass of the styrene-based resin composition (S). The contents (% by mass) of the glass filler (D) and the other inorganic fillers are shown in terms of proportion in the total of the resin mixture and the glass filler (D) as 100% by mass. The “resin mixture/inorganic filler (ratio in % by mass)” means the mass ratio of the resin mixture and the inorganic filler (i.e., the glass filler (D) and the other inorganic fillers).

### <Evaluation Method of Resin Molding Material>

The pellets (resin molding material) obtained after drying as described above were evaluated. The evaluation method was as follows.

### 1. Molding Shrinkage Ratio

A square plate molded body of 80 mm×80 mm×2 mm in thickness was molded from the resulting pellets with an injection molding machine, SE100EV (produced by Sumitomo Heavy Industries, Ltd.), at a resin temperature of 290° C. and a mold surface temperature of 160° C., and measured for the molding shrinkage ratio (MD and TD) according to ISO 294-4:2001. The results are shown in Tables 1-1 to 2-3.

### 2. Tensile Test

A dumbbell molded body having a thickness of 4 mm was molded from the resulting pellets with an injection molding machine, SE100EV (produced by Sumitomo Heavy Industries, Ltd.), at a resin temperature of 290° C. and a mold surface temperature of 160° C., and measured for the nominal tensile fracture strain according to ISO 527-1,2:2012. The results are shown in Tables 1-1 to 2-3.

### 3. MD Bending Test

The resulting pellets were molded into 80 mm×80 mm×3 mm in thickness with an injection molding machine, SE100EV (produced by Sumitomo Heavy Industries, Ltd.), at a resin temperature of 290° C. and a mold surface temperature of 160° C., and then a test specimen having a width of 10 mm (80 mm×10 mm×3 mm in thickness) was cut out in the flowing direction (MD) of the resin, and measured for the MD bending elastic modulus according to ISO 178:2010. The results are shown in Tables 1-1 to 2-3.

### 4. TD Bending Test

The resulting pellets were molded into 80 mm×80 mm×3 mm in thickness with an injection molding machine, SE100EV (produced by Sumitomo Heavy Industries, Ltd.), at a resin temperature of 290° C. and a mold surface temperature of 160° C., and then a test specimen having a width of 80 mm×10 mm×3 mm in thickness was cut out in the direction (TD) perpendicular to the flowing direction of the resin, and measured for the TD bending elastic modulus according to ISO 178:2010. The results are shown in Tables 1-1 to 2-3.

5. Izod Impact Strength (with notch)

The resulting pellets were molded into 100 mm×10 mm×4 mm in thickness with an injection molding machine, SE100EV (produced by Sumitomo Heavy Industries, Ltd.), at a resin temperature of 290° C. and a mold surface temperature of 160° C., and after forming a notch with a notching machine, measured for the Izod impact strength (with notch) according to ISO 180:2000. The results are shown in Tables 1-1 to 2-3.

### 6. Evaluation of Dielectric Characteristics (Relative Dielectric Constant and Dissipation Factor)

A test specimen of 1.5 mm×1.5 mm×80 mm formed of the resulting pellets was molded with an injection molding machine, SE100EV (produced by Sumitomo Heavy Industries, Ltd.), under condition of a resin temperature of 290° C. and a mold surface temperature of 160° C., and measured for the relative dielectric constant (εᵣ) and the dissipation factor (tan δ) at 10 GHz by the cavity resonance perturbation method according to ASTM D2520 with a network analyzer, 8757D, produced by Agilent Technologies, Inc., and a cavity resonator for 10 GHz, produced by Kanto Electronic Application and Development Inc. The results are shown in Tables 1-1 to 2-3.

### II. Production of Resin Metal Composite Body

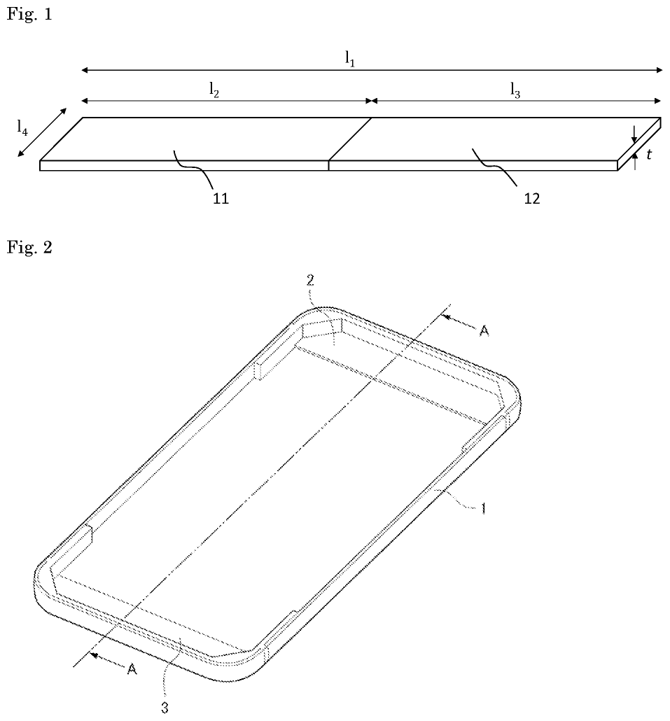

The surface of an aluminum alloy A6063 (dimension: 50 mm in length×10 mm in width×2 mm in thickness) was subjected to a degreasing treatment by immersing in an alkali degreasing solution (aqueous solution: AS-165F (produced by JCU Corporation), 50 mL/L) for 5 minutes. Subsequently, a pretreatment was performed by acid etching. Thereafter, an anodization treatment was performed to produce a metal member having plural pores. The resulting aluminum member was placed in a mold, and the resin molding material (pellets) shown in the tables was injection-molded with an injection molding machine, SE100EV (produced by Sumitomo Heavy Industries, Ltd.) (resin temperature: 290° C., mold surface temperature: 160° C., injection speed: 100 mm/s, holding pressure: 100 MPa, holding pressure time: 5 seconds), so as to provide a test specimen of the resin metal molded body. The test specimen was produced according to ISO 19095:2015 (see FIG. 1). In FIG. 1, I₁ denotes the length of the test specimen, I₂ denotes the length of the metal member 11, I₃ denotes the length of the resin member 12, I₄ denotes the width of the test specimen, and t denotes the thickness of the test specimen. I₁ was 100 mm, I₂ and I₃ each were 50 mm, I₄ was 10 mm, and t was 2 mm. The resulting test specimen was annealed at 160° C. for 1 hour, and then the test specimen was subjected to the pretreatment, the anodization treatment, and the pore sealing treatment shown below. As the pretreatment, alkali degreasing was performed by immersing in a 2.0% by mass sodium hydroxide aqueous solution at 50° C. for 1 minute, and then neutralized with 6.0% by mass diluted nitric acid (at ordinary temperature for 30 seconds). Subsequently, the specimen was chemically ground with a 90% by mass phosphoric acid-10% by mass sulfuric acid system at 86° C. for 2 minutes, and then desmutted with 6.0% by mass diluted nitric acid. The test specimen having been subjected to the pretreatment was subjected to the anodization treatment (18% by mass sulfuric acid, 18° C., 39 minutes, 1 A/dm²), and then subjected to a hot water treatment (pore sealing treatment), followed by air-blowing.

### <Evaluation Method of Resin Metal Composite Body>

### 1. Tensile Bonding Strength

The resulting test specimens of the metal resin composite bodies each were measured for the tensile bonding strength according to ISO 19095:2015. The results are shown in Tables 1-1 to 2-3.

### 2. Drop Impact (Six-Side Impact)

On the assumption of the use of the resin metal composite body of the present invention as a smartphone chassis, the bonding strength was evaluated under condition close to the actual equipment.

A test specimen for the drop impact test was produced in the following manner by changing the dimension of the metal member and a part of the molding condition of the metal resin composite body in the production method of the test specimen used for the measurement of the tensile bonding strength.

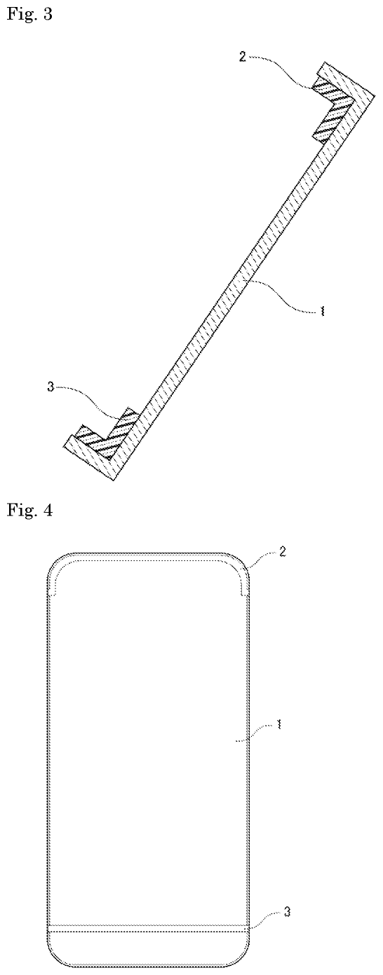

An aluminum alloy A6063 body (dimension: 160×100×10 mm in thickness) was cut for removing a portion to be filled with the resin member using a working fluid (Alphacool WA-K, produced by Idemitsu Kosan Co., Ltd.), and the surface thereof was subjected to a degreasing treatment by immersing in an alkali degreasing solution (aqueous solution: AS-165F (produced by JCU Corporation), 50 mL/L) for 5 minutes. Subsequently, a pretreatment was performed by acid etching. Thereafter, an insert metal member having plural pores on the surface thereof was produced by the anodization method. The resulting insert metal member was placed in a mold, and each of the resin molding materials (pellets) shown in Tables 1-1 to 2-3 was injection-molded to perform an integration process with the metal member with an injection molding machine, SE100EV (produced by Sumitomo Heavy Industries, Ltd.), under condition of a resin temperature of 290° C., a mold surface temperature of 160° C., an injection speed of 100 mm/s, a holding pressure of 80 MPa, and a holding pressure time of 5 seconds, so as to provide a resin metal molded body. The resulting resin metal molded body was cut for removing the unnecessary parts of resin and metal using a working fluid (Alphacool WA-K, produced by Idemitsu Kosan Co., Ltd.), so as to provide a molded body simulating a smartphone chassis (see FIGS. 2 and 3).

The resulting molded body simulating a smartphone chassis was further subjected to a surface treatment. As the pretreatment, alkali degreasing was performed by immersing in a 2.0% by mass sodium hydroxide aqueous solution at 50° C. for 1 minute, and then neutralized with 6.0% by mass diluted nitric acid (at ordinary temperature for 30 seconds). Subsequently, the molded body was chemically ground with a 90% by mass phosphoric acid-10% by mass sulfuric acid system at 86° C. for 2 minutes, and then desmutted with 6.0% by mass diluted nitric acid. The molded body having been subjected to the pretreatment was subjected to the anodization treatment (18% by mass sulfuric acid, 18° C., 39 minutes, 1 A/dm²), and then subjected to a hot water treatment (pore sealing treatment), followed by air-blowing.

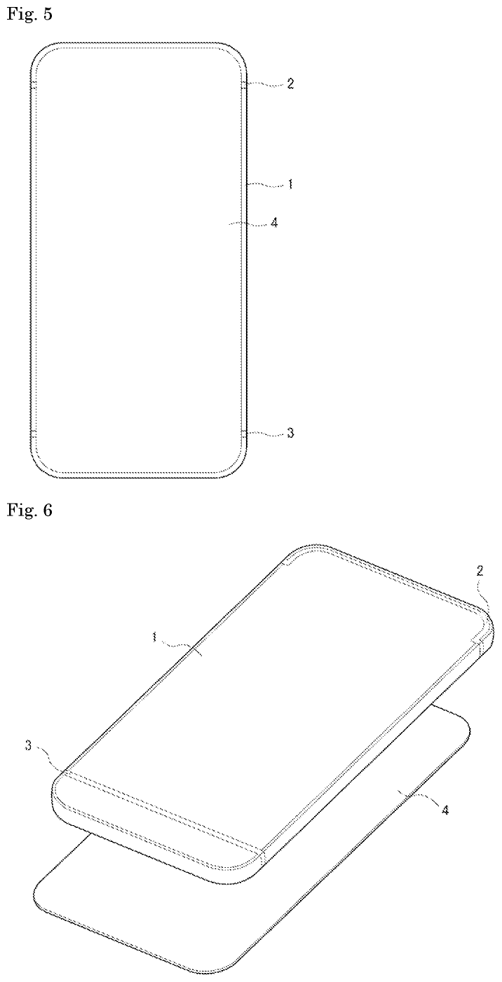

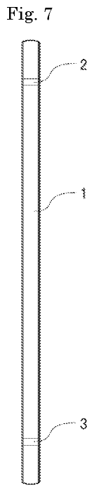

A specimen for a drop impact test was produced by combining a component for mass adjustment (which was glass in Examples and Comparative Examples) with the metal resin composite body simulating a smartphone chassis obtained making a total mass of 150 g (see FIGS. 4 to 7) uniformuly. Specifically, as shown in FIG. 6, a glass plate 4 as a component for mass adjustment was inserted in the metal resin composite body simulating a smartphone chassis, so as to provide a specimen for a drop impact test having the rear view shown in FIG. 4 and the front view shown in FIG. 5. FIG. 7 is a side view of the specimen, and as shown in the figures, the portions denoted by the symbols 2 and 3 were the resin member portions bonded to the metal member 1.

The resulting specimen for a drop impact test was dropped from each of the six sides thereof from a height of 1 m to a concrete plate with a drop tester for light weight products, DT-205H (produced by Shinyei Technology Co., Ltd.), and the occurrence of problems, such as exfoliation of the resin-metal bonding surface and fracture of the resin member, was visually confirmed.

A: No defect was visually confirmed in the drop impact test.

B: Defect was visually confirmed in the drop impact test.

TABLE 1

| | | | | | | Example | | | | | | |
|---|---|---|---|---|---|---|---|---|---|---|---|---|
| | | | | | | 1 | 2 | 3 | 4 | 5 | 6 | |
| Resin | Resin | Styrene- | SPS (A) | (A-1) 90ZC | % by mass | 78.0 | 78.0 | 68.0 | 68.0 | 78.0 | 68.0 | |
| molding | mixture | based | Rubber-like | (B-1) Septon | % by mass | 20.0 | 20.0 | 30.0 | 30.0 | 15.0 | 25.0 | |
| material | | resin | elastomer | 8006 | | | | | | | | |
| | | compo- | (B) | (B-2) H1041 | % by mass | | | | | 5.0 | 5.0 | |
| | | sition (S) | Acid-modified | | % by mass | 2.0 | 2.0 | 2.0 | 2.0 | 2.0 | 2.0 | |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | 0.5 | 0.5 | |
| | | Antioxidant | | Irganox 1010 | part by mass | 0.3 | 0.3 | 0.3 | 0.3 | 0.3 | 0.3 | |
| | Resin mixture (a1)/inorganic filler (a2) | | | | — | 80/20 | 70/30 | 80/20 | 70/30 | 80/20 | 80/20 | |
| | (ratio in % by mass) | | | | | | | | | | | |
| | Glass filler (D) | | | (D-1) ECS03T- | % by mass | 20.0 | 30.0 | 20.0 | 30.0 | 20.0 | 20.0 | |
| | | | | 249H | | | | | | | | |
| | | | | (D-2) CS(HL) | % by mass | | | | | | | |
| | | | | 301HP-3 | | | | | | | | |
| | | | | (D-3) CSG | % by mass | | | | | | | |
| | | | | 3PA-820 | | | | | | | | |
| | Other inorganic | | | Wollastonite | % by mass | | | | | | | |
| | fillers | | | Talc | % by mass | | | | | | | |
| | | | | Ca carbonate | % by mass | | | | | | | |
| Eval- | Resin | | Molding shrinkage ratio (MD) | | % | 0.5 | 0.3 | 0.3 | 0.2 | 0.3 | 0.3 | |
| uation | molding | | Molding shrinkage ratio (TD) | | % | 0.8 | 0.8 | 0.8 | 0.8 | 0.8 | 0.8 | |
| result | material | | Nominal tensile fracture strain | | % | 3.0 | 3.0 | 3.3 | 3.3 | 3.2 | 3.3 | |
| | | | Bending elastic modulus (MD) | | GPa | 6.2 | 8.5 | 5.4 | 7.8 | 6.0 | 5.4 | |
| | | | Bending elastic modulus (TD) | | GPa | 3.1 | 4.3 | 2.7 | 3.9 | 3.0 | 2.7 | |
| | | | Izod impact strength | | kJ/m² | 11.6 | 12.8 | 14.9 | 16.4 | 13.0 | 15.9 | |
| | | | (with notch) | | | | | | | | | |
| | | | Relative dielectric constant | | — | 2.75 | 2.89 | 2.75 | 2.87 | 2.74 | 2.75 | |
| | | | (10 GHz) | | | | | | | | | |
| | | | Dissipation factor (10 GHz) | | — | 0.0027 | 0.0036 | 0.0027 | 0.0034 | 0.0026 | 0.0027 | |
| | Metal resin | | Tensile bonding strength | | MPa | 25 | 28 | 22 | 23 | 24 | 21 | |
| | composite | | Drop impact (six-side impact) | | — | A | A | A | A | A | A | |
| | body | | | | | | | | | | | |
| | | | | | | Example | | | | | | |
| | | | | | | 7 | 8 | 9 | 10 | 11 | 12 | 13 |
| Resin | Resin | Styrene- | SPS (A) | (A-1) 90ZC | % by mass | 78.0 | 68.0 | 78.0 | 78.0 | 78.0 | 73.0 | 68.0 |
| molding | mixture | based | Rubber-like | (B-1) Septon | % by mass | 15.0 | 25.0 | 20.0 | 20.0 | 15.0 | 20.0 | 25.0 |
| material | | resin | elastomer | 8006 | | | | | | | | |
| | | compo- | (B) | (B-2) H1041 | % by mass | 5.0 | 5.0 | | | 5.0 | 5.0 | 5.0 |
| | | sition (S) | Acid-modified | | % by mass | 2.0 | 2.0 | 2.0 | 2.0 | 2.0 | 2.0 | 2.0 |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | 0.5 | 0.5 | 0.5 |
| | | Antioxidant | | Irganox 1010 | part by mass | 0.3 | 0.3 | 0.3 | 0.3 | 0.3 | 0.3 | 0.3 |
| | Resin mixture (a1)/ | | | | — | 70/30 | 70/30 | 80/20 | 70/30 | 70/30 | 70/30 | 70/30 |
| | inorganic filler (a2) | | | | | | | | | | | |
| | (ratio in % by mass) | | | | | | | | | | | |
| | Glass filler (D) | | | (D-1) ECS03T- | % by mass | 30.0 | 30.0 | | | | | |
| | | | | 249H | | | | | | | | |
| | | | | (D-2) CS(HL) | % by mass | | | 20.0 | 30.0 | | | |
| | | | | 301HP-3 | | | | | | | | |
| | | | | (D-3) CSG | % by mass | | | | | 30.0 | 30.0 | 30.0 |
| | | | | 3PA-820 | | | | | | | | |
| | Other inorganic | | | Wollastonite | % by mass | | | | | | | |
| | fillers | | | Talc | % by mass | | | | | | | |
| | | | | Ca carbonate | % by mass | | | | | | | |
| Eval- | Resin | | Molding shrinkage ratio (MD) | | % | 0.2 | 0.2 | 0.5 | 0.4 | 0.3 | 0.3 | 0.3 |
| uation | molding | | Molding shrinkage ratio (TD) | | % | 0.8 | 0.8 | 0.6 | 0.5 | 0.5 | 0.5 | 0.5 |
| result | material | | Nominal tensile fracture strain | | % | 3.2 | 3.4 | 2.5 | 2.6 | 2.6 | 2.6 | 2.7 |
| | | | Bending elastic modulus (MD) | | GPa | 8.5 | 7.6 | 6.0 | 8.1 | 8.0 | 7.7 | 7.4 |
| | | | Bending elastic modulus (TD) | | GPa | 4.3 | 3.8 | 3.7 | 4.9 | 5.1 | 4.7 | 4.3 |
| | | | Izod impact strength | | kJ/m² | 14.8 | 16.3 | 11.7 | 14.5 | 14.8 | 16.0 | 17.2 |
| | | | (with notch) | | | | | | | | | |
| | | | Relative dielectric constant | | — | 2.91 | 2.89 | 2.69 | 2.79 | 2.73 | 2.79 | 2.85 |
| | | | (10 GHz) | | | | | | | | | |
| | | | Dissipation factor (10 GHz) | | — | 0.0034 | 0.0034 | 0.0020 | 0.0026 | 0.0019 | 0.0022 | 0.0026 |
| | Metal resin | | Tensile bonding strength | | MPa | 26 | 22 | 25 | 28 | 26 | 24 | 22 |
| | composite | | Drop impact (six-side impact) | | — | A | A | A | A | A | A | A |
| | body | | | | | | | | | | | |
| | | | | | | Example | | | | | | |
| | | | | | | 14 | 15 | 16 | 17 | | | |
| Resin | Resin | Styrene- | SPS (A) | (A-1) 90ZC | % by mass | | | | | | | |
| molding | mixture | based | Rubber-like | (A-2) 60ZC | % by mass | 78.0 | 73.0 | | | | | |
| material | | resin | elastomer | (A-3) 30ZC | % by mass | | | | | | | |
| | | compo- | (B) | (B-1) Septon | % by mass | 15.0 | 20.0 | 15.0 | 20.0 | | | |
| | | sition (S) | | 8006 | | | | | | | | |
| | | | | (B-2) H1041 | % by mass | 5.0 | 5.0 | 5.0 | 5.0 | | | |
| | | | Acid-modified | | % by mass | 2.0 | 2.0 | 2.0 | 2.0 | | | |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | | | |
| | | Antioxidant | | Irganox 1010 | part by mass | 0.3 | 0.3 | 0.3 | 0.3 | | | |
| | Resin mixture (a1)/ | | | | — | 70/30 | 70/30 | 70/30 | 70/30 | | | |
| | inorganic filler | | | | | | | | | | | |
| | (a2) (ratio in % by mass) | | | | | | | | | | | |
| | Glass filler (D) | | | (D-1) ECS03T- | % by mass | | | | | | | |
| | | | | 249H | | | | | | | | |
| | | | | (D-2) CS(HL) | % by mass | | | | | | | |
| | | | | 301HP-3 | | | | | | | | |
| | | | | (D-3) CSG | % by mass | 30.0 | 30.0 | 30.0 | 30.0 | | | |
| | | | | 3PA-820 | | | | | | | | |
| | Other inorganic | | | Wollastonite | % by mass | | | | | | | |
| | fillers | | | Talc | % by mass | | | | | | | |
| | | | | Ca carbonate | % by mass | | | | | | | |

| Eval- | Resin | Molding shrinkage ratio (MD) | % | 0.3 | 0.3 | 0.3 | 0.3 |
|---|---|---|---|---|---|---|---|
| uation | molding | Molding shrinkage ratio (TD) | % | 0.5 | 0.5 | 0.5 | 0.5 |
| result | material | Nominal tensile fracture strain | % | 2.6 | 2.6 | 2.6 | 2.6 |
| | | Bending elastic modulus (MD) | GPa | 8.1 | 7.6 | 8.1 | 7.8 |
| | | Bending elastic modulus (TD) | GPa | 5.2 | 4.8 | 5.1 | 4.8 |
| | | Izod impact strength | kJ/m² | 14.8 | 16.2 | 14.8 | 16.2 |
| | | (with notch) | | | | | |
| | | Relative dielectric constant | — | 2.74 | 2.84 | 2.72 | 2.83 |
| | | (10 GHz) | | | | | |
| | | Dissipation factor (10 GHz) | — | 0.0020 | 0.0024 | 0.0019 | 0.0022 |

| | | | | | | |
|---|---|---|---|---|---|---|
| Metal resin | Tensile bonding strength | MPa | 27 | 24 | 27 | 24 |
| composite | Drop impact (six-side impact) | — | A | A | A | A |
| body | | | | | | |

TABLE 2

| | | | | | | Comparative Example | | | | | | |
|---|---|---|---|---|---|---|---|---|---|---|---|---|
| | | | | | | 1 | 2 | 3 | 4 | 5 | 6 | 7 |
| Resin | Resin | Styrene- | SPS (A) | (A-1) 90ZC | % by mass | 88.0 | 88.0 | 88.0 | 88.0 | 58.0 | 58.0 | 58.0 |
| molding | mixture | based | Rubber-like | (B-1) Septon | % by mass | 10.0 | 10.0 | 10.0 | 10.0 | 40.0 | 40.0 | 40.0 |
| material | | resin | elastomer | 8006 | | | | | | | | |
| | | compo- | (B) | (B-2) H1041 | % by mass | | | | | | | |
| | | sition (S) | Acid-modified | | % by mass | 2.0 | 2.0 | 2.0 | 2.0 | 2.0 | 2.0 | 0.5 |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | 0.5 | 0.5 | 0.5 |
| | | Antioxidant | | Irganox 1010 | part by mass | 0.3 | 0.3 | 0.3 | 0.3 | 0.3 | 0.3 | 0.3 |
| | Resin mixture (a1)/ | | | | — | 90/10 | 80/20 | 70/30 | 60/40 | 90/10 | 70/30 | 60/40 |
| | inorganic filler (a2) | | | | | | | | | | | |
| | (ratio in % by mass) | | | | | | | | | | | |
| | Glass filler (D) | | | (D-1) ECS03T- | % by mass | 10.0 | 20.0 | 30.0 | 40.0 | 10.0 | 30.0 | 40.0 |
| | | | | 249H | | | | | | | | |
| | | | | (D-2) CS(HL) | % by mass | | | | | | | |
| | | | | 301HP-3 | | | | | | | | |
| | | | | (D-3) CSG | % by mass | | | | | | | |
| | | | | 3PA-820 | | | | | | | | |
| | Other inorganic | | | Wollastonite | % by mass | | | | | | | |
| | fillers | | | Talc | % by mass | | | | | | | |
| | | | | Ca carbonate | % by mass | | | | | | | |
| Eval- | Resin | | Molding shrinkage ratio (MD) | | % | 0.7 | 0.5 | 0.3 | 0.1 | 0.3 | 0.2 | 0.1 |
| uation | molding | | Molding shrinkage ratio (TD) | | % | 0.9 | 0.9 | 0.8 | 0.7 | 0.8 | 0.8 | 0.8 |
| result | material | | Nominal tensile fracture strain | | % | 2.8 | 2.7 | 2.5 | 2.4 | 3.4 | 3.5 | 3.6 |
| | | | Bending elastic modulus (MD) | | GPa | 4.5 | 6.8 | 9.0 | 11.3 | 3.2 | 7.2 | 9.0 |
| | | | Bending elastic modulus (TD) | | GPa | 2.3 | 3.4 | 4.5 | 5.7 | 1.6 | 3.6 | 4.5 |
| | | | Izod impact strength | | kJ/m² | 8.0 | 9.7 | 10.8 | 12.5 | 13.7 | 16.8 | 18.2 |
| | | | (with notch) | | | | | | | | | |
| | | | Relative dielectric constant | | — | 2.61 | 2.81 | 2.98 | 3.06 | 2.61 | 2.87 | 2.97 |
| | | | (10 GHz) | | | | | | | | | |
| | | | Dissipation factor (10 GHz) | | — | 0.0020 | 0.0023 | 0.0031 | 0.0044 | 0.0020 | 0.0035 | 0.0044 |
| | Metal resin | | Tensile bonding strength | | MPa | 26 | 28 | 30 | 32 | 14 | 16 | 18 |
| | composite | | Drop impact (six-side impact) | | — | B | B | B | B | B | B | B |
| | body | | | | | | | | | | | |
| | | | | | | Comparative Example | | | | | | |
| | | | | | | 8 | 9 | 10 | 11 | 12 | 13 | 14 |
| Resin | Resin | Styrene- | SPS (A) | (A-1) 90ZC | % by mass | 78.0 | 78.0 | 68.0 | 68.0 | 80.0 | 70.0 | 76.0 |
| molding | mixture | based | Rubber-like | (B-1) Septon | % by mass | 20.0 | 20.0 | 20.0 | 30.0 | 20.0 | 20.0 | 20.0 |
| material | | resin | elastomer | 8006 | | | | | | | | |
| | | compo- | (B) | (B-2) H1041 | % by mass | 2.0 | 2.0 | 2.0 | 2.0 | 0.0 | 0.0 | 4.0 |
| | | sition (S) | Acid-modified | | % by mass | 2.0 | 2.0 | 2.0 | 2.0 | 2.0 | 2.0 | 2.0 |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | 0.5 | 0.5 | 0.5 |
| | | Antioxidant | | Irganox 1010 | part by mass | 0.3 | 0.3 | 0.3 | 0.3 | 0.3 | 0.3 | 0.3 |
| | Resin mixture (a1)/ | | | | — | 90/10 | 60/40 | 90/10 | 60/40 | 70/30 | 70/30 | 90/10 |
| | inorganic filler (a2) | | | | | | | | | | | |
| | (ratio in % by mass) | | | | | | | | | | | |
| | Glass filler (D) | | | (D-1) ECS03T- | % by mass | 10.0 | 40.0 | 10.0 | 40.0 | 30.0 | 30.0 | 10.0 |
| | | | | 249H | | | | | | | | |
| | | | | (D-2) CS(HL) | % by mass | | | | | | | |
| | | | | 301HP-3 | | | | | | | | |
| | | | | (D-3) CSG | % by mass | | | | | | | |
| | | | | 3PA-820 | | | | | | | | |
| | Other inorganic | | | Wollastonite | % by mass | | | | | | | |
| | fillers | | | Talc | % by mass | | | | | | | |
| | | | | Ca carbonate | % by mass | | | | | | | |
| Eval- | Resin | | Molding shrinkage ratio (MD) | | % | 0.6 | 0.1 | 0.4 | 0.1 | 0.2 | 0.2 | 0.6 |
| uation | molding | | Molding shrinkage ratio (TD) | | % | 0.9 | 0.7 | 0.8 | 0.8 | 0.9 | 0.8 | 0.9 |
| result | material | | Nominal tensile fracture strain | | % | 3.0 | 2.9 | 3.2 | 3.3 | 1.5 | 1.6 | 3.0 |
| | | | Bending elastic modulus (MD) | | GPa | 4.0 | 10.7 | 3.6 | 9.8 | 8.5 | 7.8 | 4.0 |
| | | | Bending elastic modulus (TD) | | GPa | 2.0 | 5.4 | 1.8 | 4.9 | 4.3 | 3.9 | 2.0 |
| | | | Izod impact strength | | kJ/m² | 9.4 | 14.9 | 12.0 | 16.2 | 4.0 | 6.6 | 9.4 |
| | | | (with notch) | | | | | | | | | |
| | | | Relative dielectric constant | | — | 2.61 | 3.04 | 2.62 | 2.99 | 2.79 | 2.87 | 2.61 |
| | | | (10 GHz) | | | | | | | | | |
| | | | Dissipation factor (10 GHz) | | — | 0.0020 | 0.0044 | 0.0020 | 0.0044 | 0.0026 | 0.0034 | 0.0020 |
| | Metal resin | | Tensile bonding strength | | MPa | 24 | 30 | 18 | 24 | 28 | 23 | 24 |
| | composite | | Drop impact (six-side impact) | | — | B | A | B | A | B | B | B |
| | body | | | | | | | | | | | |
| | | | | | | Comparative Example | | | | | | |
| | | | | | | 15 | 16 | 17 | 18 | 19 | 20 | 21 |
| Resin | Resin | Styrene- | SPS (A) | (A-1) 90ZC | % by mass | 76.0 | 78.0 | 78.0 | 78.0 | 78.0 | 78.0 | 78.0 |
| molding | mixture | based | Rubber-like | (B-1) Septon | % by mass | 20.0 | 20.0 | 20.0 | 20.0 | 20.0 | 20.0 | 20.0 |
| material | | resin | elastomer | 8006 | | | | | | | | |
| | | compo- | (B) | (B-2) H1041 | % by mass | | | | | | | |
| | | sition (S) | Acid-modified | | % by mass | 4.0 | 2.0 | 2.0 | 2.0 | 2.0 | 2.0 | 2.0 |
| | | | polyphenylene | | | | | | | | | |
| | | | ether (C) | | | | | | | | | |
| | | Nucleating agent | | NA-11 | part by mass | 0.5 | 0.5 | 0.5 | 0.5 | 0.5 | 0.5 | 0.5 |
| | | Antioxidant | | Irganox 1010 | part by mass | 0.3 | 0.3 | 0.3 | 0.3 | 0.3 | 0.3 | 0.3 |
| | Resin mixture (a1)/ | | | | — | 60/40 | 80/20 | 70/30 | 80/20 | 70/30 | 80/20 | 70/30 |
| | inorganic filler | | | | | | | | | | | |
| | (a2) (ratio in % by mass) | | | | | | | | | | | |
| | Glass filler (D) | | | (D-1) ECS03T- | % by mass | 40.0 | | | | | | |
| | | | | 249H | | | | | | | | |
| | | | | (D-2) CS(HL) | % by mass | | | | | | | |
| | | | | 301HP-3 | | | | | | | | |
| | | | | (D-3) CSG | % by mass | | | | | | | |
| | | | | 3PA-820 | | | | | | | | |
| | Other inorganic | | | Wollastonite | % by mass | | 20.0 | 30.0 | | | | |
| | fillers | | | Talc | % by mass | | | | 20.0 | 30.0 | | |
| | | | | Ca carbonate | % by mass | | | | | | 20.0 | 30.0 |

| Eval- | Resin | Molding shrinkage ratio (MD) | % | 0.3 | 0.3 | 0.3 | 0.3 | | | |
|---|---|---|---|---|---|---|---|---|---|---|
| uation | molding | Molding shrinkage ratio (TD) | % | 0.5 | 0.5 | 0.5 | 0.5 | | | |
| result | material | Nominal tensile fracture strain | % | 2.6 | 2.6 | 2.6 | 2.6 | | | |
| | | Bending elastic modulus (MD) | GPa | 8.1 | 7.6 | 8.1 | 7.8 | | | |
| | | Bending elastic modulus (TD) | GPa | 5.2 | 4.8 | 5.1 | 4.8 | | | |
| | | Izod impact strength | kJ/m² | 14.8 | 16.2 | 14.8 | 16.2 | | | |
| | | (with notch) | | | | | | | | |
| | | Relative dielectric constant | — | 2.74 | 2.84 | 2.72 | 2.83 | | | |
| | | (10 GHz) | | | | | | | | |
| | | Dissipation factor (10 GHz) | — | 0.0044 | 0.0019 | 0.0025 | 0.0015 | 0.0019 | 0.0032 | 0.0045 |

| | | | | | | | | | |
|---|---|---|---|---|---|---|---|---|---|
| Metal resin | Tensile bonding strength | MPa | 28 | 23 | 25 | 21 | 24 | 23 | 25 |
| composite | Drop impact (six-side impact) | — | A | B | B | B | B | B | B |
| body | | | | | | | | | |

### INDUSTRIAL APPLICABILITY

According to the present invention, a resin metal composite body that has a bonding portion having a sufficiently high practical bonding strength between a resin member and a metal member and has a low dielectric constant and a low dissipation factor can be provided.

### REFERENCE SIGNS LIST

11: Metal member
12: Resin member
1: Metal member
2: Resin member
3: Resin member
4: Glass

1. A resin metal composite body comprising a resin member and a metal member,
the resin member containing a resin molding material containing a resin mixture containing a styrene-based resin composition (S), and a glass filler (D), having a content of the glass filler (D) of 13.0% by mass or more and 37.0% by mass or less based on the total of the resin mixture and the glass filler (D) as 100% by mass, with the balance of the resin mixture,
the styrene-based resin composition (S) containing a styrene-based polymer having a syndiotactic structure (A), a rubber-like elastomer (B), and an acid-modified polyphenylene ether (C), having a content of the styrene-based polymer (A) of 62.0% by mass or more and 85.0% by mass or less, a content of the rubber-like elastomer (B) of 12.0% by mass or more and 37.0% by mass or less, and a content of the acid-modified polyphenylene ether (C) of 0.1% by mass or more and 3.9% by mass or less, based on the styrene-based resin composition (S) as 100% by mass.

2. The resin metal composite body according to claim 1, wherein the rubber-like elastomer (B) is a styrene-based polymer.

3. The resin metal composite body according to claim 1, wherein the acid-modified polyphenylene ether (C) is a polyphenylene ether modified with maleic anhydride or modified with fumaric acid.

4. The resin metal composite body according to claim 1, wherein the glass filler (D) is a glass filler subjected to a surface treatment.

5. The resin metal composite body according to claim 4, wherein the glass filler is D glass.

6. The resin metal composite body according to claim 4, wherein the glass filler has a fibrous form and has an elliptical fiber cross section.

7. The resin metal composite body according to claim 1, wherein the resin metal composite body is an insert molded body.

8. The resin metal composite body according to claim 1, wherein the resin mixture substantially does not contain a phosphorus-based antioxidant.

9. The resin metal composite body according to claim 1, wherein the metal member is at least one kind selected from the group consisting of aluminum, stainless steel, copper, titanium, and alloys thereof.

10. The resin metal composite body according to claim 9, wherein the metal member is aluminum or an aluminum alloy.

11. The resin metal composite body according to claim 1, wherein the metal member is subjected to at least one selected from a chemical treatment and a physical treatment on at least a surface of the metal member that is in contact with the resin member.

12. The resin metal composite body according to claim 1, wherein the metal member has pores formed on at least a surface of the metal member that is in contact with the resin member.

13. The resin metal composite body according to claim 1, wherein a test specimen of 1.5 mm×1.5 mm×80 mm of the resin member has a relative dielectric constant (εᵣ) of 2.95 or less measured at a frequency of 10 GHz according to ASTM D2520, and a dissipation factor (tan δ) of 0.0040 or less.

14. A method for producing the resin metal composite body according to claim 1, comprising injection molding the resin molding material on the metal member.

15. The method for producing the resin metal composite body according to claim 14, wherein the method further comprises subjecting the resin metal composite body obtained after injection molding, to cutting work using a working fluid.

16. A method for producing a resin metal composite body, comprising subjecting the resin metal composite body according to claim 1, to an anodization treatment and a pore sealing treatment.
